(19) United States
(12) Patent Application Publication
(10) Pub. No.: US 2011/0190673 A1
(43) Pub. Date: Aug. 4, 2011

(54) BIOMECHANICAL STIMULATION DEVICE

(76) Inventors: Ulrich Hänsenberger, Oberuzwil (CH); Viktor Wick, Niederburen (CH); Felix Lenz, Niederburen (CH); Eric J. Kline, Mogadore, OH (US)

(21) Appl. No.: 13/017,686

(22) Filed: Jan. 31, 2011

Related U.S. Application Data
(63) Continuation-in-part of application No. 12/779,618, filed on May 13, 2010.
Application No. 12/779,618 is a continuation-in-part of application No. 10/596,235, filed on Jun. 18, 2007, now abandoned.

(30) Foreign Application Priority Data
Sep. 17, 2004 (EP) 04022121.0

(51) Int. Cl. A61H 1/00

(52) U.S. Cl. 601/46

(57) ABSTRACT

A biomechanical stimulation (“BMS”) device is provided. The BMS device includes a base, and a shaft connected to said base. The shaft includes one or more first journals aligned with one or more first bearings to rotate about a first axis and one or more second journals aligned with one or more second bearings to rotate the shaft about a second axis. The second axis is offset from the first axis. A platform is connected to the shaft to rotate with the shaft. One or more elastic mounts are disposed between the platform and the base. The BMS device may include a counterweight mass to balance the shaft.

### CROSS REFERENCE TO RELATED APPLICATION

This application is a continuation-in-part of U.S. patent application Ser. No. 12/779,618 filed on May 13, 2010 which claims the benefit of priority of U.S. patent application Ser. No. 11/663,254 filed on Mar. 19, 2007, European Foreign Patent Application 04022121.0 filed on Sep. 17, 2004 and U.S. Provisional patent application Ser. No. 61/216,126 filed on May 13, 2009. This application is also a continuation-in-part U.S. patent application Ser. No. 10/596,235 filed on Jun. 18, 2007. Each of the foregoing patents and applications are hereby incorporated by reference in their entirety.

### FIELD OF INVENTION

The present invention is related to an improved device for biomechanical stimulation of muscles.

### BACKGROUND

Biomechanical muscle stimulation (BMS) was developed circa 1970 by Professor Vladimir Nararov for conditioning Soviet athletes. BMS relies on an exclusively mechanical action directly applied to human muscles by means of vibration having respectively a specific frequency and a specific amplitude that are selected in accordance with the desired application. This is in contrast to typical whole body vibration (WBV) wherein a human stands upon a vibrating surface and vibration forces are transmitted to the muscles and tendons by way of bones and joints. The vibrations, which resemble and imitate the natural vibrations of the body, act upon the strained or expanded muscles along the muscle fiber. By purposively influencing the vibrational parameters of the body BMS thus generates positive effects on the blood circulation and lymphatic systems.

For example, the improved movements of the muscles caused by BMS may allow the concerned body part to experience significantly increased blood circulation. This technique can be used for the treatment of diseases such as disturbances of the peripheral blood circulation.

On the other hand, with the aid of BMS one can also specifically evoke a build-up of muscles which can be exploited in the area of sports, but also in the health area—for example for the build-up of muscles in the course of recovery treatments.

Moreover, BMS can be used in the cosmetic area e.g. against the generation of wrinkles or cellulites.

In the prior art there have already been described devices for carrying out BMS, e.g. in DE-A-199 44 456, DE-U-201 16 277 or in DE-U-202 19 435. Therein, BMS is carried out using randomly generated vibrations in more or less linear (vertical) direction. A lift is generated which has an adverse influence on the user. Moreover, those devices are thus construed that only a limited number of body parts, e.g. only the leg or arm region, can be treated with BMS.

Therefore, an improved device for biomechanical stimulation is needed.

### SUMMARY

A biomechanical stimulation (“BMS”) device is provided. The BMS device includes a base, and a shaft connected to said base. The shaft includes one or more first journals aligned with one or more first bearings to rotate about a first axis and one or more second journals aligned with one or more second bearings to rotate the shaft about a second axis. The second axis is offset from the first axis. A platform is connected to the shaft to rotate with the shaft. One or more elastic mounts are disposed between the platform and the base.

It has been found that BMS can be advantageously carried out if the stimulation is generated by a uniform circular or elliptical movement. In contrast to the devices of the prior art, with the device according to the present invention thus not only a force perpendicular to the platform is exerted but also a traction force substantially parallel to the platform. This leads to a significantly improved biomechanical stimulation of the body part which is present in the platform.

According to the present invention, thus a device is provided comprising a base plate, a pedestal connected with said base plate and a platform connected to said pedestal via a driving device, characterized in that the platform executes a circular or elliptical movement about an axis which is located outside of the centre of gravity of the platform, thereby undergoing a parallel displacement.

### BRIEF DESCRIPTION OF THE DRAWINGS

Objects and advantages together with the operation of the invention may be better understood by reference to the following detailed description taken in connection with the following illustrations, wherein:

FIG. 1 illustrates movement of the device described herein.

FIG. 2 illustrates an embodiment of a BMS device.

FIG. 3 illustrates a perspective cut-away view of an embodiment of a BMS device.

FIG. 4 illustrates a front cut-away view of an embodiment of a BMS device.

FIG. 5 illustrates a perspective view of an embodiment of a BMS device.

FIG. 6 illustrates a first side view of an embodiment of a BMS device.

FIG. 7 illustrates a second side view of an embodiment of a BMS device.

FIG. 8 illustrates a perspective view of a shaft incorporated in an embodiment of a BMS device.

FIG. 9 illustrates a perspective view of a motor and shaft in an embodiment of a BMS device.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the present invention.

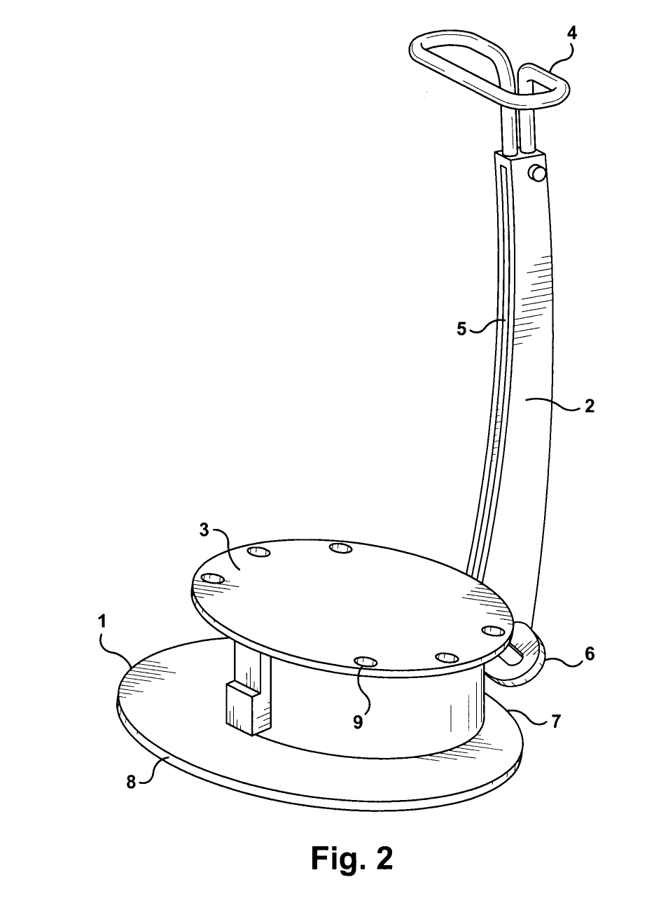

An embodiment of a BMS device is shown in FIG. 2. The BMS device includes a base plate 1 supporting a shorter portion and a pedestal 2 having an L-form shape. The shorter portion is surrounded by a cover 7. In an opening situated in this shorter portion, a driving unit for driving a platform 3 is provided. In this embodiment, the driving unit is an eccentric drive evoking circular movement of the platform 3. At the end of the shorter portion, there is additionally provided a user unit 8 for controlling the device. At the lower end of the pedestal 2, two wheels 6 may be provided to allow a more simple transportation of the device. At the upper end of the longer portion of the pedestal 2, there may be a grip 4 that a user may hold during usage of the device.

A ribbon 5 may be provided along the longer portion of the pedestal 2. The ribbon 5 facilitate a connection, such as an electrical connection, with the driving unit in the pedestal 2. The device may be controlled by interacting with the ribbon 5, such as by pushing the ribbon 5.

The platform 3 is moveably connected with the driving unit which is located in the pedestal 2 (in its portion which is surrounded by the cover 7), such that the platform 3 may be moved in a circular or elliptical fashion by the driving unit. As can be gathered from FIG. 2, the surface of the platform 3 has a lower surface area than the surface of the base plate 1. Therefore, during usage the user may stand also on the base plate 1, and only locate specific body parts on the platform 3, allowing a specific BMS of those body parts. Moreover, on the platform 3 there are openings 9. Through these openings, cords or ribbons for additional exercises may be provided.

During usage, the platform 3 may execute a uniform circular or elliptical movement. In contrast to the devices of the prior art, which exercise a random movement, the BMS device may provide controlled, uniform movement. It has been found that biomechanical muscle stimulation may be carried much more efficiently through controlled uniform movement than through random non-uniform movements. In contrast to the devices of the prior art, the BMS device may execute both a force vertical to the platform and a traction force substantially parallel to the platform. Thus, the present device provides a force in a first dimension perpendicular to the platform and a force in a second dimension parallel to the platform, restricting motion of the platform to these two dimensions. The parallel force and perpendicular for provide movement of the platform within a two-dimensional plane that is perpendicular to the base. This rigid body motion results in a significantly improved biomechanical stimulation of the body part being located on the platform.

While a circular movement of the platform 3 may be preferred, it will be appreciated that the platform may be moved in any directional motion such as ovular movement or other types of movement known in the art. As used herein, “circular movement” may mean a movement that does not deviate more than 5% from true circular movement.

The axis around which the platform is moved in a circular manner can be located at random. It is preferred that this axis is located parallel to the base plate below the platform and in particular perpendicular to an axis which vertically extends through the pedestal.

In an embodiment, the movement is carried out with a frequency of 5 to 35 Hz.

The circular or elliptical movement of the platform 3 can be generated by common driving units which are known in the art. For example, the movement may be generated by an eccentric drive. The shaft of an eccentric drive may be connected to the platform 3 via conventional units such as bars, castors, bearings, belts or gear wheels.

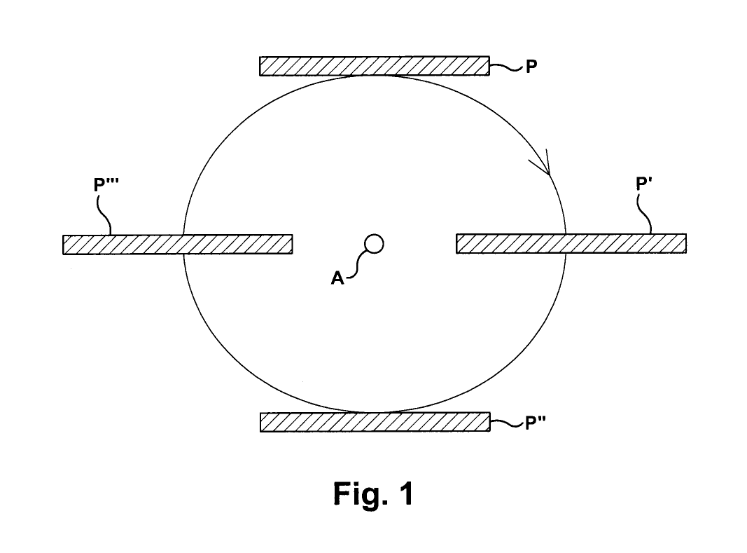

An example of circular movement of the platform 3 is shown in FIG. 1. The platform P moves around the axis A. During this rotation, the platform P is thus tilted. Thereby, the platform P undergoes a parallel displacement. The platform P (i.e. the platform in the starting position) and the platform P′ (i.e. the platform after a rotation of 90.degree.) as well as the platform P″ (i.e. the platform after a rotation of 180.degree.) and the platform P′″ (i.e. the platform after a rotation of 270.degree.) are thus parallel to each other, respectively. The lift of the platform during this movement is preferably not more than 4 mm.

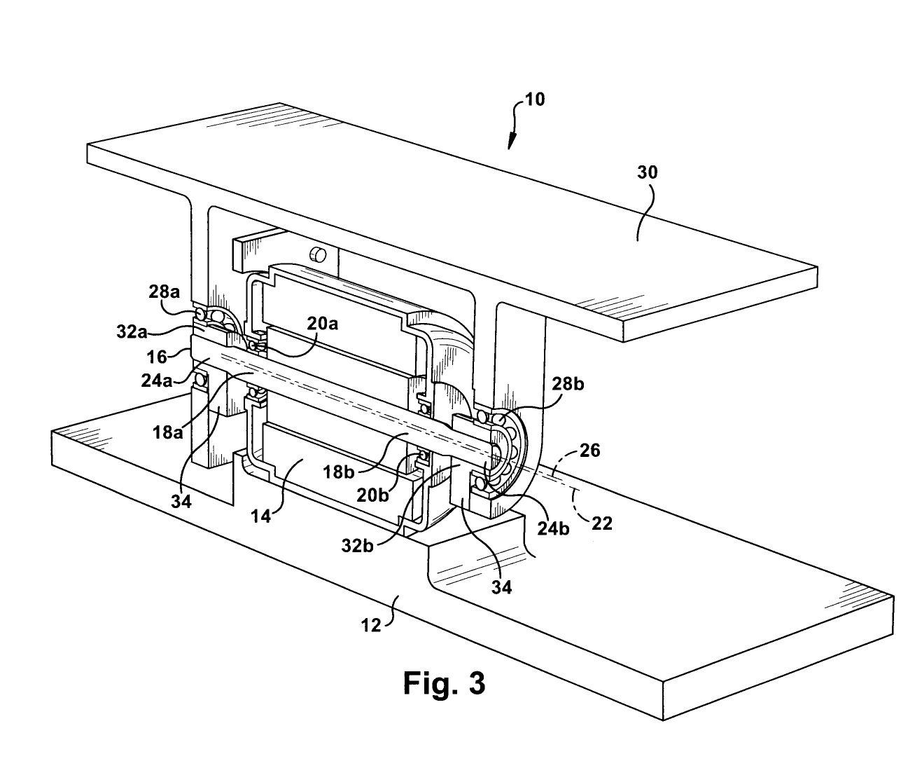

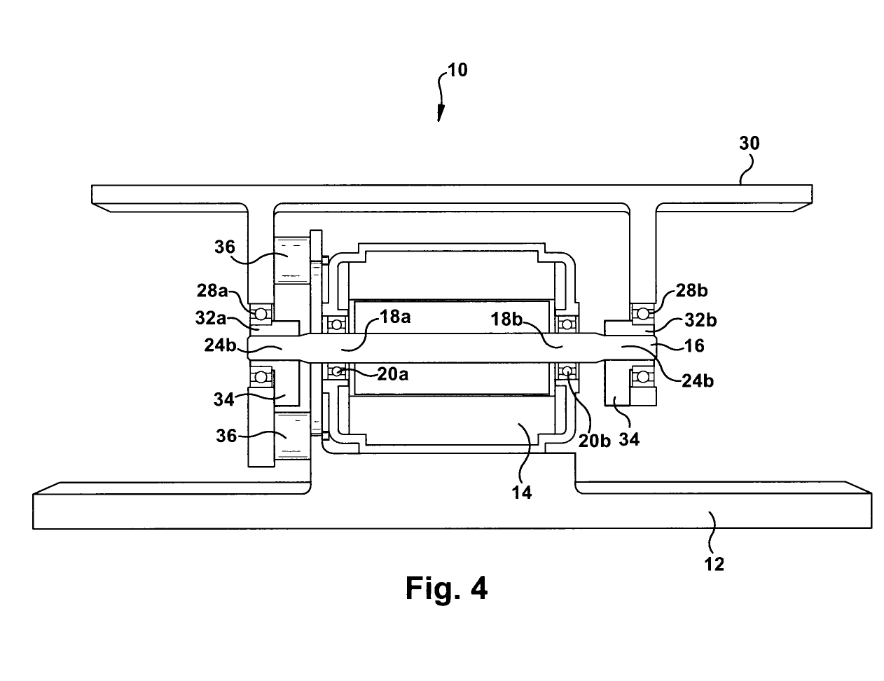

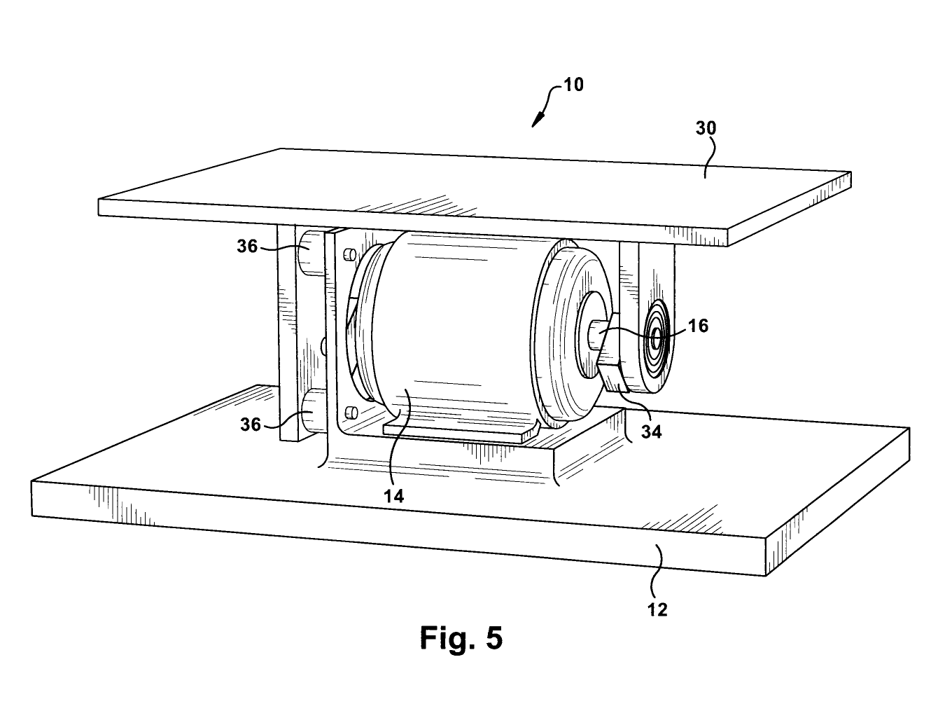

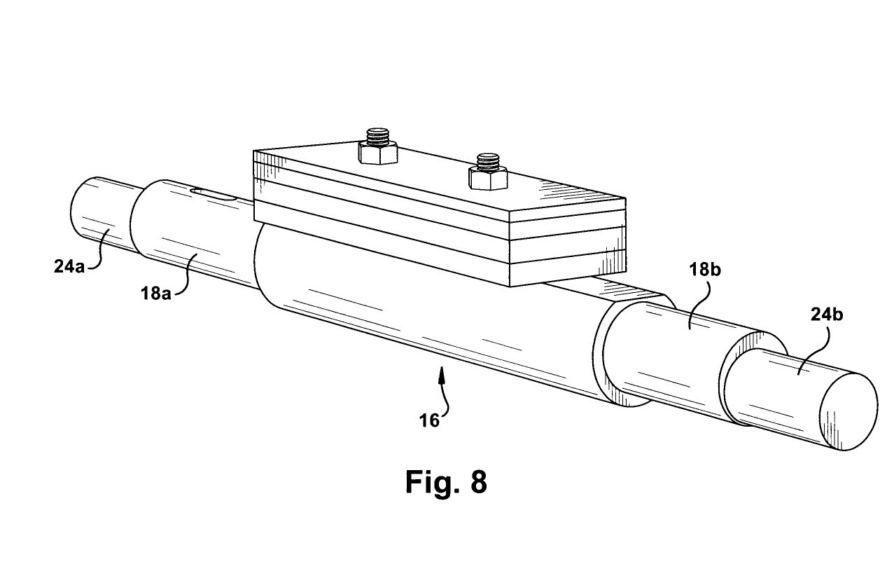

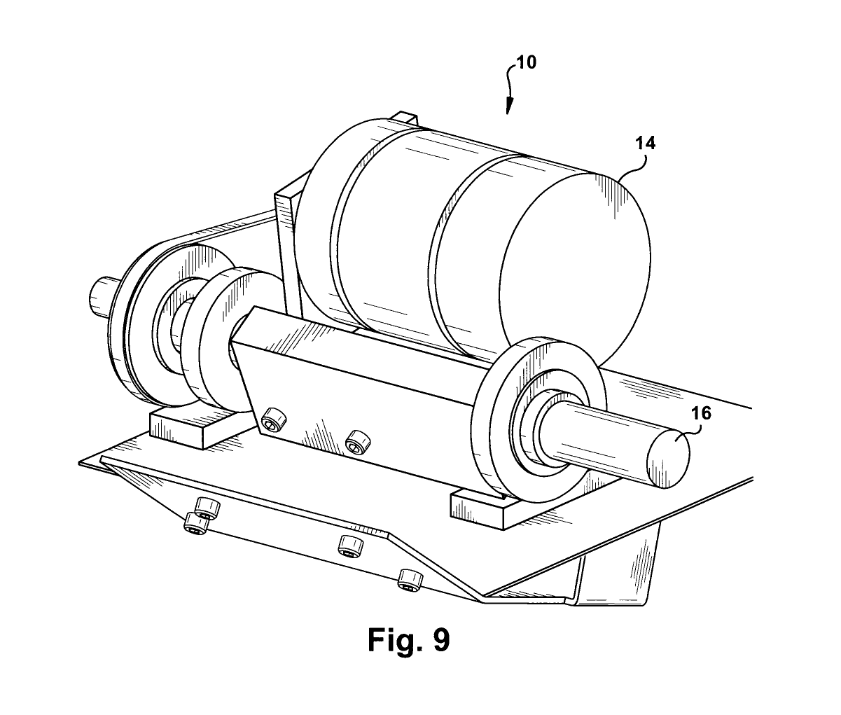

An embodiment of a BMS device is illustrated in FIGS. 3-9. As shown, the BMS device 10 may comprise a base 12. The base 12 may be any appropriate size and shape and may be generally configured to be supported by the ground or a stationary surface. The base 12 may support other parts or components of the device 10.

The device may include a motor 14 or similar drive device. The motor 14 may be an electric motor, such as an AC or DC motor.

The motor may be configured to rotate a shaft 16. The shaft 16 may be a single, unitary part or may comprise a plurality of parts. The shaft 16 may include one or more journals, including a first pair of journals 18a, 18b. The first pair of journals 18a, 18b may be located at any appropriate position along the shaft, such as aligned with a first pair of bearings 20a, 20b. The first pair of journals 18a, 18b may be concentric to a common horizontal first axis 22.

The first pair of bearings 20a, 20b may be concentric about the first axis 18. The bearings 20a, 20b constrain the shaft 16 to rotate about the axis 22. In an embodiment, the bearings 20a, 20b and shaft 16 are integral parts of, and are directly driven by, the motor 14. It will be appreciated, however, that the shaft 16 may be driven indirectly by the motor 14 through any combination of drive train components such as gears, belts, or chains.

The shaft may further include a second pair of journals 24a, 24b. The second pair of journals 24a, 24b may be located at any appropriate position along the shaft, such as outside of the first pair of journals 18a, 18b respectively. The second pair of journals 24a, 24b may be concentric to an eccentric second axis 26. The eccentric second axis 26 may be parallel but offset, or eccentric to, the first axis 22.

A second pair of bearings 28a, 28b may be concentrically located about the eccentric axis 26 and aligned with the second pair of journals 24a, 24b. The second pair of bearings 28a, 28b may be connected to a platform 30 to facilitate movement of the platform 30. The platform 30 may be any appropriate size and shape and may include a generally horizontal surface, as illustrated in FIGS. 3-9.

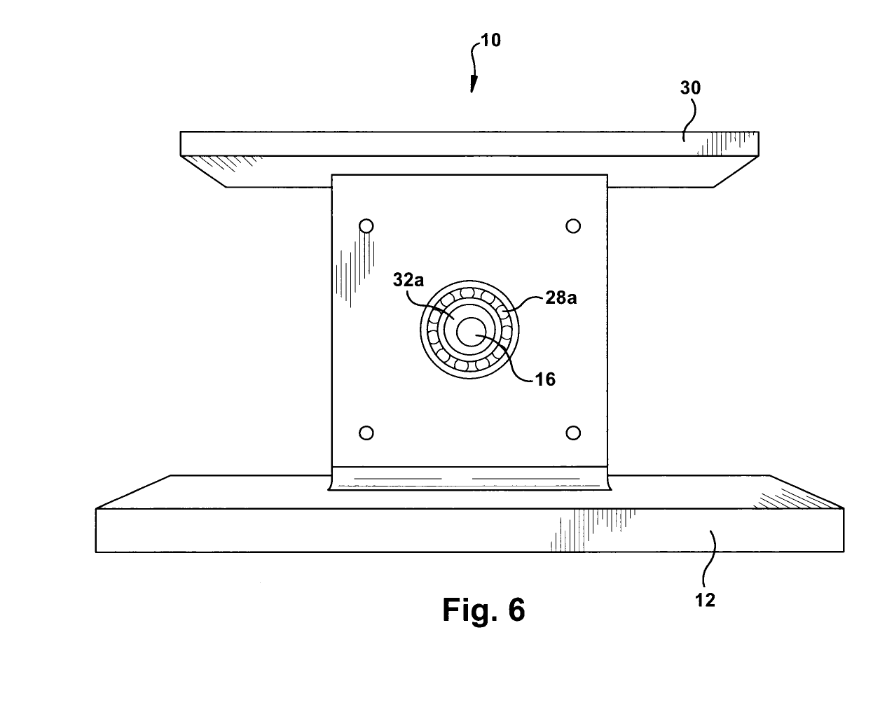

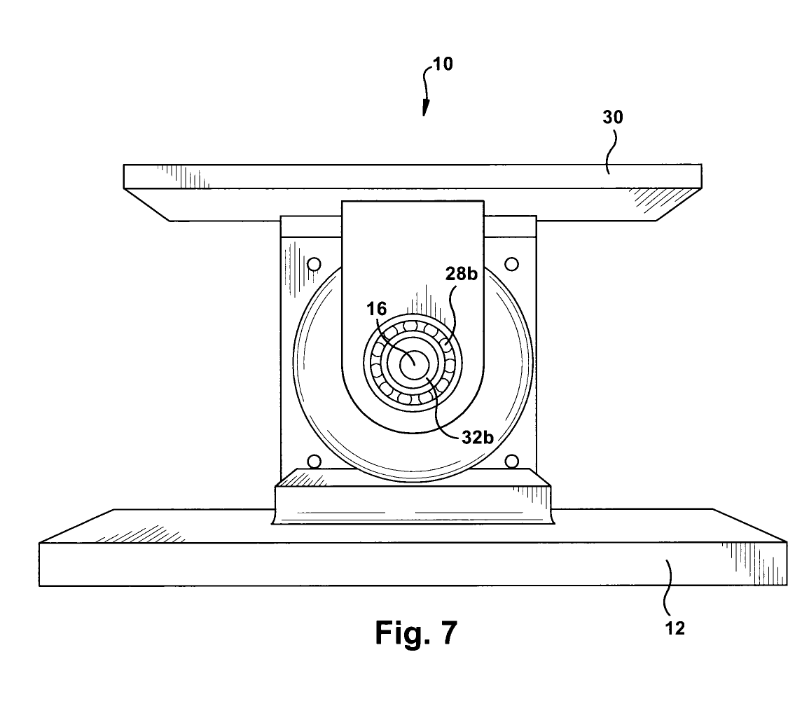

In an embodiment best shown in FIGS. 6 and 7, the second pair of journals 24a, 24b may comprise bushings 32a, 32b affixed to the shaft, such as keyed thereto. The bushings 32a, 32b may be eccentric bushings 32a, 32b and configured such that the second pair of journals 24a, 24b are concentric about the eccentric second axis 26.

In an embodiment, the bushings 32a, 32b include a counterweight mass 34 that is sized and located so as to neutralized the unbalance caused by the platform 30 moving eccentrically about the first axis 22. The counterweight mass 34 may be divided among one or more locations. Moreover, it will be appreciated that the counterweight mass 34 may be integrally formed with the bushings 32, integrally formed with the shaft 16, or otherwise connected or interconnected to the shaft 16, as is known in the art.

As is known in the art, the mass of the counterweights multiplied by the distance of their center of gravity from the first axis 22 may equal the mass of the platform and other moving parts multiplied by the distance of their center of gravity from the first axis 22. Furthermore, these centers of gravity should oppose each other and lie in a common plain with each other that passes through the first axis 22. The amount of unbalance in individual devices can be reduced to an arbitrarily small amount by using standard two-plane dynamic balancing techniques.

The platform 30 is additionally connected to the base 12 by a plurality of elastic mounts 36. The elastic mounts 36 may be any appropriate size and shape and may allow for movement perpendicular to the first axis 22, but with increasing resistance as displacement increases. Thus, the elastic mounts 36 may effectively limit rotation of the platform 30 while allowing translation of platform 30. The mounts 36 may be comprised of elastomeric vibration sandwich mounts, metallic springs, or any other material or materials known in the art.

The elastic mounts 36 may exhibit uniform stiffness in all directions perpendicular to axis 22. Thus, the mounts 36 may be arranged about said axis 22 in any number of configurations. To obtain the circular orbit of the said platform 30, however, the centroid of said mounts 36 must be positioned coincident with the first axis 22. This arrangement results substantially in a purely rigid body translation, with no rotation of the platform 30 such that each point on the platform 30 translates in a circular orbit in a plane perpendicular to the first axis 22. To maximize the platform's 30 resistance to rotation about the first axis 22, the mounts 36 may be placed as far as practical from the axis 22.

In some embodiments, the centroid of the elastic mounts 36 may be positioned not coincident with the first axis 22. In such embodiments, rigid body motion of the platform 30 will result in minor cyclical rotation about the first axis 22, meaning that each point on the platform 30 will follow an approximately elliptical orbit. The elliptical orbit's orientation and eccentricity may vary based on each point's position relative to the first axis 22 and the centroid of the elastic mounts 36. Such embodiments may be desirable for achieving specific elliptical motion of certain regions of the platform 30.

Adding additional elastic mounts 36 or utilizing stiffer mounts 36 may cause greater resistance to rotation and result in purer translational motion of the platform 30. Such modifications, however, may impose higher radial loads on the bearings, and a higher degree of torque pulsing on the motor 14 because in typical practice, the centroid of the elastic mounts 36 does not align perfectly with the first axis 22. Hysteresis of the mounts 36 will decrease energy efficiency of the system.

The eccentric second axis 26 may be offset from the first axis 22 by a distance of 0.5 to 5 mm, with 2 mm being a preferred distance. Rotational speed of shaft 16 may be controlled between 0 to 60 Hz, with 5 to 35 Hz being a preferred range.

Other preferred embodiments of device may include features such as: a non-moving handle fixed to base 12; wheels for making device portable; a protective guard around the moving components; soft padding or other appropriate surface material on the surface(s) of the platform 30; and a motor speed and direction controller. In some embodiments, attachment points on the platform 30 allow for attachment of cords or ribbons which can transmit motion to a users arms, shoulders, or other body parts which are pulling on said cords or ribbons.

The device of the present invention may be used in the field of sports, cosmetics or health. In the field of sports, the buildup of muscles as well as the increase of the endurance performance of the user is in the primary focus. In the field of cosmetics, the device may be used, for example, against cellulites or the formation of wrinkles In the health sector, the device of the present invention may be used for example in the following treatments: Weakness of connective tissue, degenerative rheumatic diseases, migraine, muscular tension or weakness, pain in the muscular or locomotor system, build-up of muscles in the case of amyotrophia of muscles, degenerative alterations of the spinal disk (arthosis), fractures, diseases of joints (e.g. of the elbow of persons exercising tennis or golf), lack of stability of joints, myelosis, problems related to the shoulder, the back, the hip, the knees or the ankle, problems with blood circulation, congestion syndromes (Ulcus cruris), resorption of edemas, neuropathies, strengthening the metabolism, aconuresis, multiple sclerosis, muscle dystrophy, Parkinson disease, stroke, arthrogenic (venous) congestive syndrome, Ehlers-Danlos syndrome, Sklerodermia, Periodontosis problems with the mandible joints, improvement of blood circulation in the visual nerve, strengthening the muscles of the circumorbital ring, Facial nerve paresis, problems related to the frontal and maxillary sinuses, chronic rhinitis, Tinnitus aurium and Osteoporosis.

The embodiments of the invention have been described above and modifications and alternations will occur to others upon reading and understanding this specification. The claims as follows are intended to include all modifications and alterations insofar as they come within the scope of the claims or the equivalent thereof.

We claim:

1. A biomechanical stimulation device comprising:
a base;
a shaft connected to said base, said shaft comprising:
one or more first journals aligned with one or more first bearings to rotate about a first axis; and
one or more second journals aligned with one or more second bearings to rotate said shaft about a second axis, offset from said first axis;
a platform connected to said shaft to rotate therewith; and
one or more elastic mounts disposed between said platform and said base.

2. The biomechanical stimulation device of claim 1 further comprising a motor configured to drive said shaft.

3. The biomechanical stimulation device of claim 2, wherein said shaft is integral with said motor.

4. The biomechanical stimulation device of claim 1 further comprising one or more bushings positioned within one or more of said first bearings or said second bearings.

5. The biomechanical stimulation device of claim 4, wherein said one or more bushings are eccentric bushings.

6. The biomechanical stimulation device of claim 4 further comprising a counterweight mass.

7. The biomechanical stimulation device of claim 6, wherein said counterweight mass is unitarily formed with said bushing.

8. The biomechanical stimulation device of claim 6, wherein said counterweight is directly connected to said shaft.

9. The biomechanical stimulation device of claim 1, wherein said second axis is offset from said first axis by a distance of approximately 2 millimeters.

10. The biomechanical stimulation device of claim 1, wherein the shaft is rotatable between speeds of 5 Hz and 35 Hz.

11. The biomechanical stimulation device of claim 1, wherein said elastic mounts are comprised of an elastomeric material.

12. The biomechanical stimulation device of claim 1, wherein said elastic mounts are arranged about said first axis such that a centroid of said elastic mounts is approximately coincident with said first axis.

13. The biomechanical stimulation device of claim 1 further comprising one or more wheels connected to said base.

14. The biomechanical stimulation device of claim 1 further comprising a motor controller.
